(19) United States
(12) Patent Application Publication
(10) Pub. No.: US 2025/0079483 A1
(43) Pub. Date: Mar. 6, 2025

(54) LIQUID-GAS SEPARATOR ASSEMBLIES AND METHODS FOR ROUTING EXHAUST WATER AWAY FROM FUEL CELL SYSTEMS

(71) Applicant: GM GLOBAL TECHNOLOGY OPERATIONS LLC, Detroit, MI (US)

(72) Inventors: Dawid Siekierka, Livonia, MI (US); Daryl J. D'Andrea, Holly, MI (US); Patrick M. Hoover, Keego Harbor, MI (US); Andrei Balaceanu, Whitby (CA)

(73) Assignee: GM GLOBAL TECHNOLOGY OPERATIONS LLC, Detroit, MI (US)

(21) Appl. No.: 18/459,635

(22) Filed: Sep. 1, 2023

(51) Int. Cl. H01M 8/04119; B60L 50/72

(52) U.S. Cl. CPC H01M 8/04164; B60L 50/72; H01M 2250/20

(57) ABSTRACT

Presented are liquid-gas (LG) separator assemblies for segregating air and water in fuel cell system (FCS) exhaust streams, methods for making/using such assemblies, and FCS-powered vehicles equipped with such assemblies. An LG separator assembly includes a quick-connect (QC) fitting with a fitting body having a first open end, which couples to an exhaust pipe of the FCS to thereby receive an exhaust stream expelled from the FCS. An LG separator unit has a separator body with opposite open ends, a first of which couples to a second open end of the fitting body to thereby releasably couple to the exhaust pipe and receive therefrom the exhaust stream through the QC fitting. The LG separator unit extracts liquid water entrained within the exhaust stream, ejects the extracted water through a water nozzle located within the separator body, and expels the remaining exhaust stream through a second end of the separator body.

### INTRODUCTION

The present disclosure relates generally to electrochemical fuel cell systems for converting hydrogen-rich fuels into electricity. More specifically, aspects of this disclosure relate to devices for separating water from air in FCS exhaust streams.

Current production motor vehicles, such as the modern-day automobile, are originally equipped with a powertrain that operates to propel the vehicle and power the vehicle's onboard electronics. In automotive applications, for example, the vehicle powertrain is generally typified by a prime mover that delivers driving torque through an automatic or manually shifted power transmission to the vehicle's final drive system (e.g., differential, axle shafts, corner modules, road wheels, etc.). Automobiles have historically been powered by a reciprocating-piston type internal combustion engine (ICE) assembly due to its ready availability and relatively inexpensive cost, light weight, and overall efficiency. Such engines include compression-ignited (CI) diesel engines, spark-ignited (SI) gasoline engines, two, four, and six-stroke architectures, and rotary engines, as some non-limiting examples. Hybrid-electric and full-electric vehicles (collectively “electric-drive vehicles”), on the other hand, utilize alternative power sources to propel the vehicle and, thus, minimize or eliminate reliance on a fossil-fuel based engine for tractive power.

Hybrid-electric and full-electric powertrains take on various architectures, some of which utilize a fuel cell system (FCS) to generate the requisite electricity for powering the vehicle's electric traction motor(s). A fuel cell is an electrochemical device that is generally composed of an anode electrode that receives hydrogen (H₂), a cathode electrode that receives oxygen (O₂), and an electrolyte barrier interposed between the anode and cathode electrodes. An electrochemical reaction is induced to oxidize hydrogen molecules at the anode side of the FCS—hydrogen gas is catalytically split in an oxidation half-cell reaction—to generate free electrons (−) and free protons (H+). The free hydrogen protons pass through the electrolyte to the cathode, where these protons react with oxygen and electrons in the cathode to form stack reaction by-products. Free electrons from the anode, however, cannot pass through the electrolyte; these electrons are redirected to a load, such as a vehicle's traction motors and accessories, before being sent to the cathode.

Fuel cell architectures commonly employed in automotive applications contain a semipermeable polymer electrolyte membrane—also referred to as a “proton exchange membrane” or “PEM”- to provide ion transport between the anode and cathode. Proton exchange membrane fuel cells (PEMFC) generally employ a solid polymer electrolyte (SPE) proton-conducting membrane, such as a perfluorosulfonic acid membrane, to separate product gases and provide electrical insulation of the electrodes in addition to facilitating the conduction of protons. The anode and cathode typically include finely dispersed catalytic particles (e.g., platinum) that are supported on carbon particles and mixed with an ionomer. For some fuel cell manufacturing processes, this catalytic mixture may be deposited on the sides of the membrane to form the anode and cathode layers. The combination of the anode catalytic layer, cathode catalytic layer, and electrolyte membrane define a membrane electrode assembly (MEA) in which the anode catalyst and the cathode catalyst are supported on opposite faces of the ion conductive solid polymer membrane.

To generate the necessary electricity for powering a motor vehicle, numerous fuel cells are typically combined, in series or in parallel, into a fuel cell stack to achieve a higher output voltage and allow for stronger current draw. For example, a typical fuel cell stack for an automobile may have in excess of two hundred stacked cells. These fuel cell stacks receive reactant gas as a cathode input, typically as a metered flow of ambient air or concentrated gaseous oxygen forced through the stack by a compressor. During normal operation, a quantifiable mass of the oxygen is not consumed by the stack; some of the remnant oxygen is output as cathode waste gas that may include water as a stack by-product. The fuel cell stack also receives hydrogen or hydrogen-rich reactant gas as an anode input that flows into the anode side of the stack. The distribution of hydrogen within the anode flow channels is typically held substantially constant for proper fuel cell stack operation. Exhaust generated as a byproduct of fuel cell operation may include water vapor, liquid water, air, and negligible levels of waste hydrogen and nitrogen gases. In some operational modes, waste hydrogen may be recycled and recirculated back into the fuel cell stack so that the anode gas is evenly distributed to achieve a calibrated stack output load. Additionally, a fuel cell stack may be operated in a manner that maintains the MEAs in a humidified state in which gases supplied to the fuel cell stack are humidified with waste water to prevent drying of the MEAs.

### SUMMARY

Presented below are liquid-gas (LG) separator assemblies for segregating air and water in fuel cell system exhaust streams, methods for making and methods for using such separator assemblies, and FCS-powered vehicles equipped with such separator assemblies. In an example, there are presented passive-type separator assemblies that extract liquid water entrained in a fuel cell system's exhaust stream and route the extracted water for on-vehicle storage or off-vehicle discharge. The LG separator assembly may be a bipartite construction that consists essentially of a quick-connect (QC) fitting that releasably mounts onto an open end of an FCS exhaust pipe, and a liquid-gas separator unit that rigidly mounts onto the QC fitting. For tripartite constructions, the liquid-gas separator assembly may consist essentially of the QC fitting, the separator unit, and a flexible water hose that is fluidly connected to a water nozzle projecting from the separator unit. The QC fitting may contain a retaining-ring spring and an annular gasket for friction fitting and thereby fluidly sealing to the open end of the FCS exhaust pipe. The separator unit, on the other hand, may be crimped, clamped, or otherwise rigidly secures onto an open end of the QC fitting. During stationary vehicle operation, FCS exhaust flows out of the exhaust pipe, passes through the QC fitting, and feeds into an open proximal (top) end of the separator unit. The separator unit may be a helical-type water separator that uses centripetal force and surface friction of an internal helical ramp enclosed within a cylindrical body to force entrained liquid water into an axially elongated water nozzle inside the separator unit. The extracted water is expelled through the separator unit's water nozzle and into the water hose while the surplus exhaust gas is expelled through an open distal (bottom) end of the separator unit.

Attendant benefits for at least some of the disclosed concepts include a lightweight and inexpensive assembly for passively separating water from exhaust gases without the use of moving parts or active electronic components. Other attendant benefits may include a liquid-gas separator assembly with universal connectors and porting that can be scaled to practically any FCS architecture, e.g., for routing water away from a vehicle. Use of a quick-connect fitting allows a user to rapidly attach and detach the separator assembly to/from the fuel cell system without the use of tools, welds, adhesives, fasteners, or brackets. Additionally, use of a compact separator unit and a flexible fluid hose helps to simplify assembly integration while minimizing assembly packaging requirements.

Aspects of this disclosure are directed to passive-type separator assemblies for extracting entrained water from exhaust gases expelled from fuel cell systems, including both automotive and non-automotive fuel cell system (FCS) applications. In an example, there is presented a liquid-gas separator assembly for a fuel cell system. The LG separator assembly may be a two-piece construction with a quick-connect fitting and an LG separator unit or may be a three-piece construction that also includes a flexible water hose. The QC fitting has a fitting body with opposing open ends, a first of which securely couples to an open end of an FCS exhaust pipe to thereby receive an exhaust stream expelled from the FCS. The LG separator unit has a separator body with opposing open ends, a first of which is coupled to a second open end of the fitting body to thereby releasably couple the LG separator assembly to the FCS's exhaust pipe and receive therefrom the exhaust stream through the QC fitting. The LG separator unit is structurally configured to extract liquid water that is entrained in the exhaust stream, eject the extracted water through a water nozzle that extends axially within the separator body, and expel the remaining exhaust stream through a second open end of the separator body.

Additional aspects of this disclosure are directed to electric-drive vehicles with electrified powertrains containing traction motors powered by fuel cell systems employing any of the disclosed separator assemblies. As used herein, the terms “vehicle” and “motor vehicle” may be used interchangeably and synonymously to include any relevant vehicle platform, such as passenger vehicles (ICE, HEV, FEV, fully and partially autonomous, etc.), commercial vehicles, industrial vehicles, tracked vehicles, off-road vehicles (ORV) and all-terrain vehicles (ATV), motorcycles, farm equipment, watercraft, aircraft, etc. For non-automotive applications, disclosed concepts may be implemented for all logically relevant uses, including stand-alone power stations, portable power packs, backup generator systems, pumping equipment, residential, commercial and industrial uses, electric vehicle charging stations (EVCS), etc.

In an example, an electric-drive vehicle includes a vehicle body with a passenger compartment, multiple road wheels mounted to the vehicle body (e.g., via corner modules coupled to a unibody or body-on-frame chassis), and other standard original equipment. An electrified powertrain contains one or more vehicle-mounted traction motors that operate alone (e.g., for FEV powertrains) or in conjunction with an internal combustion engine assembly (e.g., for HEV powertrains) to selectively drive one or more of the road wheels and thereby propel the vehicle. A resident FCS, which is mounted to the vehicle, oxidizes a hydrogen-based fuel to thereby generate an FCS voltage to power the electrified powertrain (either directly or through a traction battery pack). The FCS includes a stack of fuel cells, an exhaust manifold that collects exhaust gases and byproducts from the cells in the stack, and evacuates the exhaust from the FCS through an exhaust pipe.

Continuing with the discussion of the preceding example, the vehicle is also equipped with a liquid-gas separator assembly that passively separates entrained water from the exiting FCS exhaust stream. The separator assembly includes a QC fitting that is fabricated with a hollow body having longitudinally spaced and opposing open ends. A first open end of the QC fitting body is physically mounted on and fluidly sealed to the FCS's exhaust pipe to thereby receive the exhaust stream expelled from the FCS. The separator assembly also includes an LG separator unit that is fabricated with an elongated separator body having longitudinally spaced and opposing open ends. A first open end of the separator body is physically mounted on and fluidly sealed to a second open end of the fitting body to thereby releasably couple the LG separator unit to the FCS exhaust pipe and receive therefrom the exhaust stream passing through the QC fitting. The LG separator unit is structurally configured to passively extract liquid water entrained in the exhaust stream, eject the extracted water through a hollow and cylindrical water nozzle that extends axially through the center of the separator body and projects from a second open end thereof, and expel the remaining exhaust stream through this second open end.

Aspects of this disclosure are also directed to manufacturing workflow processes, system control logic, and computer-readable media (CRM) for making and/or using any of the disclosed separator assemblies. In an example, a method is presented for manufacturing a liquid-gas separator assembly for a fuel cell system. This representative method includes, in any order and in any combination with any of the above and below disclosed options and features: fabricating, retrieving, and/or inputting (collectively “receiving”) a quick-connect fitting having a fitting body with opposing first and second open QC ends; coupling the first open QC end of the fitting body to an FCS exhaust pipe to thereby receive an exhaust stream expelled from an FCS; receiving a liquid-gas separator unit having a separator body with opposing first and second open LG ends; and coupling the first LG open end of the separator body to the second open QC end to thereby releasably couple the LG separator unit to the FCS exhaust pipe and receive therefrom the exhaust stream through the QC fitting, the LG separator unit being configured to extract liquid water entrained in the exhaust stream, eject the liquid water through a water nozzle extending axially within the separator body, and expel the exhaust stream through the second open LG end.

For any of the disclosed assemblies, vehicles, and methods, the separator body may contain a proximal (first) internal fluid chamber that adjoins the separator body's top (first) open end, a distal (second) internal fluid chamber that adjoins the separator body's bottom (second) open end, and a helical ramp that is interposed between and axially separates these two internal fluid chambers. As a further option, the water nozzle may include a hollow cylinder that is coaxially aligned with the opposing open ends of the separator body; in this instance, the helical ramp may adjoin and wrap axially around the hollow cylinder of the water nozzle. The water nozzle's hollow cylinder may have longitudinally spaced, opposing open ends that are concentrically aligned with the two open ends of the separator body, e.g., such that a flow-restricted volume of the exhaust stream pushes the extracted water through the water nozzle.

For any of the disclosed assemblies, vehicles, and methods, the LG separator unit may also include a dam wall that projects axially from a terminal end of the helical ramp and extends radially inward from an interior surface of the separator body. In this instance, the water nozzle may include a fluid port that extends transversely through the hollow cylinder and aligns with a radially inward end of the dam wall, e.g., such that the dam wall obstructs liquid water flowing down the helical ramp and directs the water into the fluid port. It may be desirable that the LG separator unit—the separator body, water nozzle, helical ramp, dam wall, etc.—be integrally formed as a unitary, single-piece structure (e.g., injection molded from polypropylene (PP)). To help minimize or eliminate backpressure within the FCS exhaust pipe, the opening diameters of the open ends of the LG separator body may be approximately equal to or greater than the pipe diameter of the FCS exhaust pipe. In this instance, the water nozzle, which may be concentrically aligned with the open ends of the separator body, may have a nozzle diameter that is less than the diameter of the FCS exhaust pipe.

For any of the disclosed assemblies, vehicles, and methods, the QC fitting may include a spring and a seal, both of which are physically attached to the fitting body. The spring and seal are cooperatively configured to friction fit the QC fitting onto the FCS exhaust pipe. The second (bottom) open end of the fitting body, on the other hand, may be inserted into and crimped or clamped to the top (first) open end of the separator body. As a further option, the QC fitting may be a twist-lock QC fitting, a luer-lock QC fitting, a ball-and-sleeve QC fitting, a cam-lock QC fitting, and/or a friction-fit QC fitting. It may be desirable that the liquid-gas separator assembly be characterized by a lack of electrical components and consists essentially of the QC fitting and the LG separator unit. As a further option, the LG separator assembly may also include a flexible water hose that is coupled to an open (bottom) end of the water nozzle to thereby transfer extracted water away from the FCS. In this instance, the LG separator assembly may be characterized by a lack of electrical components and a lack of moving components, and may consist essentially of the QC fitting, LG separator unit, and flexible water hose.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is an elevated, perspective-view illustration of a representative motor vehicle with an inset schematic illustration of a rechargeable energy storage system (RESS) containing a traction battery pack and a fuel cell system for operating the electric motor(s) of an electrified powertrain according to aspects of the disclosed concepts.

FIG. 2 is a perspective-view illustration of a representative passive-type liquid-gas separator assembly for a fuel cell system in accord with aspects of disclosed concepts.

FIG. 3 is a partially exploded, front perspective-view illustration of the representative liquid-gas separator assembly of FIG. 2.

FIG. 4 is a sectional front-view illustration of the representative liquid-gas separator assembly of FIG. 2.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Description of the Drawings, and Detailed Description sections, but not explicitly set forth in the claims, should not be incorporated into the claims, singly or collectively, by implication, inference, or otherwise. Moreover, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this Detailed Description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

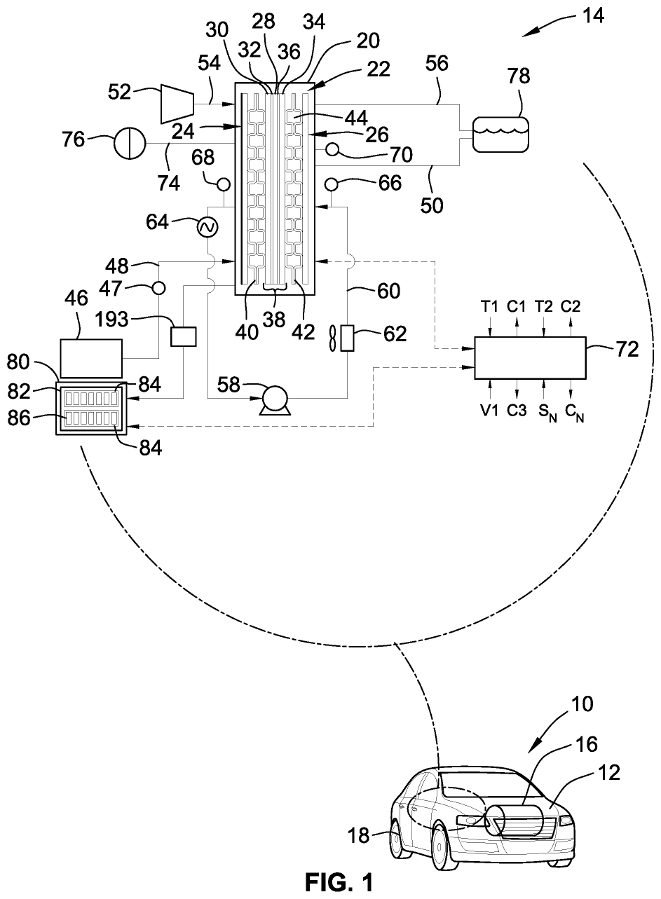

Referring now to the drawings, wherein like reference numbers refer to like features throughout the several views, there is shown in FIG. 1 a representative automobile, which is designated generally at 10 and portrayed herein for purposes of discussion as a sedan-style, fuel cell electric vehicle (FCEV). The illustrated automobile 10—also referred to herein as “motor vehicle” or “vehicle” for short—is merely an exemplary application with which aspects of this disclosure may be practiced. In the same vein, incorporation of the present concepts into the illustrated proton exchange membrane fuel cell (PEMFC) system should be appreciated as a non-limiting implementation of disclosed features. As such, it will be understood that aspects and features of this disclosure may be applied to other fuel cell system (FCS) architectures, incorporated into any logically relevant type of vehicle, and implemented for both automotive and non-automotive applications alike. Moreover, only select components of the motor vehicles, fuel cell systems, and LG separator assemblies are shown and described in additional detail herein. Nevertheless, the vehicles, systems and assemblies discussed below may include numerous additional and alternative features, and other available peripheral components, for carrying out the various methods and functions of this disclosure.

Packaged within the vehicle body 12 of automobile 10 is a representative fuel cell system 14 for powering a prime mover, such as an electric motor generator unit (MGU) 16, that is operable for driving any one or more of the vehicle's road wheels 18. Proton exchange membrane fuel cell system 14 of FIG. 1 is equipped with one or more fuel cell stacks 20, each of which is composed of multiple fuel cells 22 of the PEM type that are stacked and connected in electrical series or parallel with one another. In the illustrated architecture, each fuel cell 22 is a multi-layer construction with an anode side 24 and a cathode side 26 that are separated by a proton-conductive perfluorosulfonic acid membrane 28. An anode diffusion media layer 30 is provided on the anode side 24 of the PEMFC 22, with an anode catalyst layer 32 interposed between and operatively connecting the membrane 28 and corresponding diffusion media layer 30. Juxtaposed in opposing spaced relation to the anode layers 30 and 32 is a cathode diffusion media layer 34, which is provided on the cathode side 26 of the PEMFC 22. A cathode catalyst layer 36 is interposed between and operatively connects the membrane 28 and corresponding diffusion media layer 34. The two catalyst layers 32 and 36 cooperate with the membrane 28 to define, in whole or in part, a membrane electrode assembly (MEA) 38.

The diffusion media layers 30 and 34 are porous constructions that provide for fluid inlet transport to and fluid exhaust transport from the MEA 38. An anode flow field plate (or “first plate”) 40 is provided on the anode side 24 in abutting relation to the anode diffusion media layer 30. In the same vein, a cathode flow field plate (or “second plate”) 42 is provided on the cathode side 26 in abutting relation to the cathode diffusion media layer 34. Coolant flow channels 44 traverse each of the plates 40 and 42 to allow cooling fluid to flow through the fuel cell 22. Fluid inlet ports and headers direct a hydrogen-rich fuel and an oxidizing agent to respective passages in the anode and cathode flow field plates 40, 42. A central active region of the anode's plate 40 that faces the proton-conductive membrane 28 may be fabricated with an anode flow field composed of serpentine flow channels for distributing hydrogen over an opposing face of the membrane 28. The MEA 38 and plates 40, 42 may be stacked together between stainless steel clamping plates and monopolar end plates (not shown). These clamping plates may be electrically insulated from the end plates by a gasket or dielectric coating. The fuel cell system 14 may also employ anode recirculation where an anode recirculation gas is fed from an exhaust manifold or headers through an anode recirculation line for recycling hydrogen back to the anode side 24 input so as to conserve hydrogen gas in the stack 20.

Hydrogen (H₂) inlet flow—be it gaseous, concentrated, entrained, or otherwise—is transmitted from a hydrogen source, such as fuel storage tank 46, to the anode side 24 of the fuel cell stack 20 via a fluid injector 47 coupled to a (first) fluid intake conduit or hose 48. Anode exhaust exits the stack 20 via a (first) fluid exhaust conduit or hose 50. Although shown on the anode side of the stack, a compressor or pump 52 forces a cathode inlet flow, such as ambient air and/or concentrated gaseous oxygen (O₂), via a (second) fluid intake line or manifold 54 to the cathode side 26 of the stack 20. Cathode exhaust is output from the stack 20 via a (second) fluid exhaust conduit or hose 56. Flow control valves, flow restrictions, filters, and other available devices for regulating fluid flow can be implemented by the PEMFC system 14 of FIG. 1. Electricity generated by the fuel cell stack(s) 20 and output by the fuel cell system 14 may be transmitted for storage to an in-vehicle traction battery pack 82 within a rechargeable energy storage system (RESS) 80.

Fuel cell system 14 of FIG. 1 may also include a thermal sub-system operable for controlling the temperature of the fuel cell stack 20 during preconditioning, break-in, and post-conditioning. According to the illustrated example, a cooling fluid pump 58 pumps a cooling fluid through a coolant loop 60 to the fuel cell stack 20 and into the coolant channels 44 in each cell 22. A radiator 62 and an optional heater 64 fluidly coupled in the coolant loop 60 are used to maintain the stack 20 at a desired operating temperature. This fuel cell conditioning system may be equipped with various sensing devices for monitoring system operation and progress of fuel cell break-in. For instance, a (first) temperature sensor 66 monitors a temperature value of the coolant at a coolant inlet to the fuel cell stack 20, and a (second) temperature sensor 68 measures a temperature value of the coolant at a coolant outlet of the stack 20. An electrical connector or cable 74 connects the fuel cell stack 20 to an electric power load 76, which may be employed to draw a current from each cell 22 in the stack 20. A voltage/current sensor 70 is operable to measure, monitor, or otherwise detect fuel cell voltage and/or current across the fuel cells 22 in the stack 20.

Programmable electronic control unit (ECU) 72 helps to control operation of the fuel cell system 14. As an example, ECU 72 receives temperature signals T1 from temperature sensors 66, 68 that indicate the operating temperature of the fuel cell stack 20; ECU 72 may be programmed to responsively issue command signals C1 to modulate operation of the stack 20. ECU 72 of FIG. 1 also receives voltage signals V1 from a voltage sensor/current 70; ECU 72 may be programmed to responsively issue command signals C2 to modulate operation of a hydrogen source (e.g., fuel storage tank 46) and/or compressor/pump 52 to thereby regulate the electrical output of the stack 20. ECU 72 of FIG. 1 is also shown receiving coolant temperature signals T2 from sensor 66 and/or 68; ECU 72 may be programmed to responsively issue command signals C3 to modulate operation of the fuel cell's thermal system. Additional sensor signals S_{N} may be received by, and additional control commands C_{N} may be issued from the ECU 72, e.g., to control any other sub-system or component illustrated and/or described herein. The ECU 72 may emit a command signal to transmit evolved hydrogen and liquid H₂O from the cathode side 26 through fluid exhaust conduit 56 to a storage tank 78 (FIG. 1) where hydrogen and water from the cathode are combined with depleted hydrogen exhausted from the anode through fluid exhaust conduit/hose 50.

With continuing reference to FIG. 1, the traction battery pack 82 of RESS 80 may contain an array of rechargeable lithium-class (secondary) battery modules 84. Aspects of the disclosed concepts may be similarly applicable to other electric storage unit architectures, including those employing nickel metal hydride (NiMH) batteries, solid-state (SS) batteries, lithium-metal and lithium-sulfur batteries, or other applicable type of rechargeable electric vehicle battery (EVB). Each battery module 84 may include a series of electrochemical battery cells, such as pouch-type lithium ion (Li-ion) or Li-ion polymer battery cells 86. An individual battery module 84, for example, may be typified by a grouping of 10-45 Li-ion battery cells that are stacked in side-by-side facing relation with one another and connected in parallel or series for storing and supplying electrical energy. While described as silicon-based, Li-ion “pouch cell” batteries, the cells 86 may be adapted to other constructions, including cylindrical and prismatic constructions. To boost the voltage output of the vehicle FCS, a respective DC-to-DC boost converter (DC CON) 193 may be electrically interposed between the fuel cell stack 20 and the RESS 80.

During operation of the motor vehicle 10, the vehicle's fuel cell system 14 produces exhaust that may contain liquid water, humidified air entrained with water vapor, low levels of waste hydrogen gas, and other non-toxic trace elements. For some vehicle configurations, these byproducts of FCS operation are expelled from the vehicle; when the vehicle is stationary, liquid water entrained within the FCS exhaust stream may be ejected onto the road surface and may amalgamate into a puddle. While some FCEV architectures may recycle metered amounts of waste water back into the FCS, e.g., to humidify the cell stack, or stow waste water in an on-vehicle storage tank, e.g., for drinking, most do not provide a means for routing exhaust water away from the vehicle using an auxiliary device. Those vehicles that are plumbed with hardware for managing FCS exhaust water typically employ expensive and complicated electromechanical devices or cumbersome mechanical devices that require moving parts and large amounts of packing space.

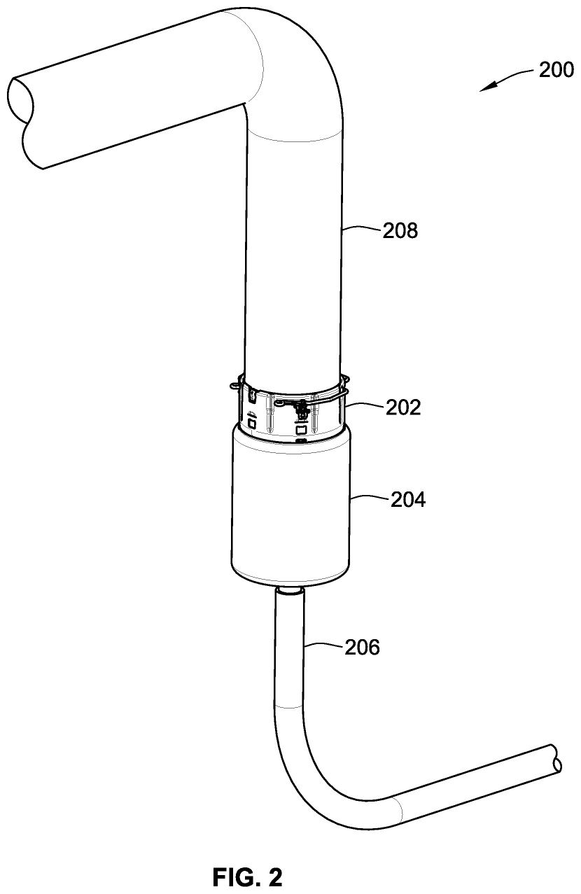

Presented below are light-weight and compact liquid-gas (LG) separator assemblies for extracting liquid water from fuel cell system exhaust and routing the extracted water for on-vehicle storage or off-vehicle discharge. FIG. 2 shows an example of a system-integrated, passive-type LG separator assembly 200 for segregating exhaust water in a fuel cell system, such as proton exchange membrane FCS 14 of FIG. 1, and expelling the extracted water from the FCS, such as jettisoning the water from the vehicle 10. In accord with the illustrated example, the separator assembly 200 may be a bipartite construction that includes a quick-connect (QC) fitting 202 that operatively attaches to an open end of an FCS exhaust pipe 208, and a liquid-gas separator unit 204 that operatively attaches to the QC fitting 202 on a side thereof opposite that of the exhaust pipe 208. For a tripartite construction, the separator assembly 200 may also include a flexible water hose 206 that operatively attaches to the separator unit 204 on a side thereof opposite that of the QC fitting 202. When integrated into a motor vehicle 10, a bipartite design of the separator assembly 200 may be interposed between the exhaust hoses 50, 52 and the storage tank 78 using, for example, a manifold connector (not shown) to combine the anode and cathode exhaust from their respective sides of the stack 20. A tripartite variation of the separator assembly 200, on the other hand, may replace the storage tank 78 and, thus, allow liquid water to be discarded from the vehicle body 12. It should be appreciated that the separator assembly 200 may be packaged at other locations relative to the FCS 14 of FIG. 1 and may be composed of greater, fewer, or alternative components than what are shown in FIG. 2.

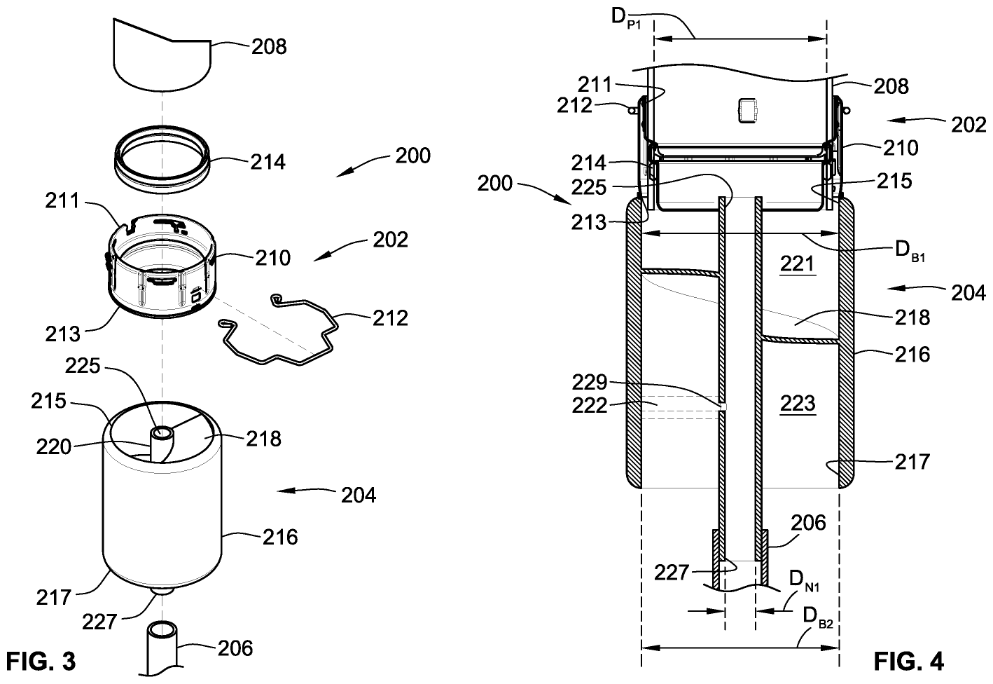

The quick-connect fitting 202 enables an assembly line operator or system user to rapidly attach and detach the LG separator assembly 200 to/from the fuel cell system, e.g., without the use of tools, welding, adhesives, fasteners, or brackets. As shown in FIGS. 3 and 4, the QC fitting 202 is fabricated with an annular fitting body 210 that has a hollow core interposed between an open top end 211 (first open end) that is longitudinally spaced from and opposite an open bottom end 213 (second open end). The open top end 211 of the QC fitting body 210 securely couples to an open terminal end of the FCS exhaust pipe 208 and, in so doing, receives exhaust expelled from the FCS. It is envisioned that the QC fitting 202 may take on several form factors, including a twist-lock QC fitting, a luer-lock QC fitting, a ball-and-sleeve QC fitting, a cam-lock QC fitting, and/or a friction-fit QC fitting, the latter of which is shown in the Figures and described in further detail below.

According to the illustrated example, the QC fitting 204 of FIGS. 2-4 employs a spring element, such as a U-shaped retaining-ring spring 212, and a sealing element, such as an annular gasket seal 214, that are operatively attached to the QC fitting body 210 and cooperatively configured to both sealingly engage and friction fit the QC fitting 202 onto the terminal end of the FCS exhaust pipe 208. The retaining-ring spring 212, which is shown mounted onto an outer-diameter (OD) surface of the fitting body 210 proximal the top end 211 thereof, slides onto and presses against an OD surface of the exhaust pipe 208 when the QC fitting 202 is pressed onto the pipe 208. Conversely, the gasket seal 214 is shown mounted inside the fitting body 210 abutting an interior surface thereof proximal the open bottom end 213; the gasket seal 214 compresses against an inner-diameter (ID) surface of the exhaust pipe 208 when the pipe 208 slides down into the QC fitting body 210. It may be advantageous that the QC fitting body 210 be manufactured as a one-piece construction from a deep-drawn material, such as a sheet of stainless steel.

Located fluidly downstream from the QC fitting 202, inserted in-line between the exhaust pipe 208 and water hose 206, is an LG separator unit 204 that is structurally configured to extract liquid water from the exhaust stream expelled from the FCS, e.g., without the use of any moving parts or electronic components. As shown in FIGS. 3 and 4, the separator unit 204 is fabricated with an elongated, cylindrical separator body 216 that has an open top end 215 (first open end) that is longitudinally spaced from and opposite an open bottom end 217 (second open end). The open top end 215 of the LG separator body 216 securely couples, e.g., via crimping, clamping, threading, or interference fit, to the open bottom end 213 of the QC fitting body 210 and, in so doing, receives exhaust that is expelled from the FCS through the QC fitting 202. It is envisioned that the LG separator unit 204 may take on innumerable form factors, including a tube-type (centrifugal) air-water separator and a ramp-type (centripetal) air-water separator, the latter of which is shown in the Figures and described in further detail below.

According to the illustrated example, the LG separator unit 204 of FIGS. 2-4 contains a top (first) internal fluid chamber 221 that adjoins the open top end 215 of the separator body 216 and faces the FCS exhaust pipe 208. Also disposed inside the separator unit 204 is a bottom (second) internal fluid chamber 223 that adjoins the bottom open end 217 of the separator body 216 and faces the water hose 206. A helical ramp 218 is interposed between and separates the two longitudinally spaced internal fluid chambers 221, 223 contained in the separator body 216. While not per se limited, the helical ramp 218 may be a right-handed, cylindrical helix with a single helical turn (only half of the helical ramp 218 is visible in the cross-sectional view of FIG. 4). As another option, a total volume of the top fluid chamber 221 may be less than a total volume of the bottom fluid chamber 223.

Extending axially through the center of the LG separator unit body 216 is a water nozzle 220 through which the liquid water extracted by the separator unit 204 is expelled from the separator body 216. For simplicity of design and manufacture, the water nozzle 220 may be a hollow, right-circular cylinder that is coaxially aligned with the opposing open ends 215, 217 of the LG separator body 216, as best seen in FIG. 4. This hollow cylindrical nozzle 220 has opposing top (first) and bottom (second) open nozzle ends 225 and 227, respectively, that are concentrically aligned with the top and bottom open ends 215 and 217 of the separator body 216. While not per se required, the top-most proximal end 225 of the water nozzle 220 may be circumscribed by and substantially coplanar with the top end 215 of the LG separator body 216, whereas the bottom-most distal end 227 of the water nozzle 220 may project axially past the bottom end 217 of the body 216. It is envisioned that the water nozzle 216 may take on alternative lengths, diameters, and shapes without departing from the intended scope of this disclosure.

Using centripetal force and surface friction, for example, the helical ramp 218 extracts liquid water from the FCS exhaust stream and directs the extracted water into the water nozzle 220 inside the LG separator unit 204. The helical ramp 218, which projects inward from an ID surface of the separator body 216, adjoins and wraps helically around the OD surface the cylindrical water nozzle 220. Projecting axially upward at an oblique angle from a bottom-most terminal end of the helical ramp 218 is a dam wall (shown hidden at 222 in FIG. 4) that extends radially inward from the ID surface of the separator body 216. A fluid port (shown hidden at 229 in FIG. 4) extends transversely through the water nozzle's 220 cylinder wall and is aligned with a radially inner-most end of the dam wall 222. With this arrangement, the dam wall 222 obstructs liquid water that is flowing down the helical ramp 218 and directs the flowing water into the fluid port 229. It may be desirable that the LG separator unit 204, including the separator body 216, helical ramp 218, water nozzle 220, and dam wall 222, be integrally formed as a unitary, single-piece structure (e.g., injection molded from polypropylene (PP)).

During operation of the LG separator assembly 200, the top-most proximal end of the water hose 206 is pressed onto or otherwise fluidly coupled with the bottom end 227 of the water nozzle 220. If the separator unit 204 and QC fitting are not preassembled as a single unit, the top end 215 of the LG separator unit body 216 is securely coupled to the open bottom end 213 of the QC fitting 202. The QC fitting 202 is then pressed onto and thereby releasably coupled with the FCS exhaust pipe 208 such that the LG separator unit 204 receives the exhaust stream exiting the FCS through the QC fitting 202. For other quick-connect form factors, a top segment of the fitting may be rigidly attached to the exhaust pipe, a bottom end of the fitting may be rigidly attached to the separator unit, and the two fitting segments are releasably mated with each other. When the FCS is active, the LG separator unit 204 extracts liquid water entrained in the exhaust stream, ejects the extracted water through the water nozzle 220, and expels the remnant exhaust stream through the open bottom end 217 of the separator unit 204. The top end 225 of the central water nozzle 220 may be open such that a flow-restricted volume of the exhaust stream flows down into the nozzle 220 and pushes the extracted water out through the bottom end 227 of the nozzle 220 and into the water hose 206.

To help minimize or eliminate unwanted backpressure within the FCS exhaust pipe 208, an internal (first) body diameter D_{B1} of the open top end 215 of the separator body 216 and an internal (second) body diameter D_{B2} of the bottom open end 217 of the separator body 216 may be greater than or equal to an internal pipe diameter D_{P1} of the exhaust pipe 208. In accord with the illustrated example, the internal diameters D_{B1}, D_{B2} of the top and bottom ends 215, 217 of the separator body 216 are substantially equal to each other and are both greater than the exhaust pipe's 208 internal diameter D_{P1}. As a further option, the central water nozzle 220 may have an internal nozzle diameter D_{N1} that is less than the exhaust pipe's 208 internal diameter D_{P1} and less than both of the internal body diameters D_{B1}, D_{B2}. To minimize system cost, size, and complexity, the liquid-gas separator assembly 200 may lack electrical components and the LG separator unit 204 may lack moving parts. In the same vein, the liquid-gas separator assembly 200 may consist essentially of the QC fitting 202 and LG separator unit 204 (i.e., for a bipartite construction) or may consist essentially of the QC fitting 202, LG separator unit 204, and flexible water hose 206 (i.e., for a tripartite construction).

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A liquid-gas separator assembly for a fuel cell system (FCS), the FCS including a fuel cell stack and an FCS exhaust pipe fluidly connected to the fuel cell stack and configured to expel an exhaust stream from the FCS, the liquid-gas separator assembly comprising:
a quick-connect (QC) fitting having a fitting body with opposing first and second open QC ends, the first open QC end of the fitting body being configured to couple to the FCS exhaust pipe to thereby receive the exhaust stream expelled from the FCS; and
a liquid-gas (LG) separator unit having a separator body with opposing first and second open LG ends, the first LG open end of the separator body being coupled to the second open QC end to thereby releasably couple to the FCS exhaust pipe and receive therefrom the exhaust stream through the QC fitting, the LG separator unit being configured to extract liquid water entrained in the exhaust stream, eject the liquid water through a water nozzle extending axially within the separator body, and expel the exhaust stream through the second open LG end.

2. The liquid-gas separator assembly of claim 1, wherein the separator body contains a first internal fluid chamber adjoining the first LG open end, a second internal fluid chamber adjoining the second LG open end, and a helical ramp interposed between and separating the first and second internal fluid chambers.

3. The liquid-gas separator assembly of claim 2, wherein the water nozzle includes a hollow cylinder coaxially aligned with the first and second LG open ends of the separator body, and the helical ramp adjoins and wraps helically around the hollow cylinder of the water nozzle.

4. The liquid-gas separator assembly of claim 3, wherein the hollow cylinder of the water nozzle has opposing first and second open nozzle ends concentrically aligned with the first and second LG open ends of the separator body.

5. The liquid-gas separator assembly of claim 3, wherein the LG separator unit further includes a dam wall projecting from a terminal end of the helical ramp and extending radially inward from an interior surface of the separator body, and wherein the water nozzle includes a fluid port extending transversely through the hollow cylinder and aligned with a radially inward end of the dam wall.

6. The liquid-gas separator assembly of claim 5, wherein the LG separator unit, including the separator body, the water nozzle, the helical ramp, and the dam wall, is integrally formed as a single-piece structure.

7. The liquid-gas separator assembly of claim 1, wherein the FCS exhaust pipe has a pipe diameter, the first LG open end of the separator body has a first diameter, and the second LG open end has a second diameter, the first and second diameters being approximately equal to or greater than the pipe diameter.

8. The liquid-gas separator assembly of claim 7, wherein the water nozzle is concentrically aligned with first and second LG open ends and has a nozzle diameter that is less than the pipe diameter of the FCS exhaust pipe.

9. The liquid-gas separator assembly of claim 1, wherein the QC fitting includes a spring and a seal attached to the fitting body and cooperatively configured to friction fit the QC fitting onto the FCS exhaust pipe, and wherein the second open QC end of the fitting body is crimped to the first LG open end of the separator body.

10. The liquid-gas separator assembly of claim 1, wherein the QC fitting is a twist-lock QC fitting, a luer-lock QC fitting, a ball-and-sleeve QC fitting, a cam-lock QC fitting, or a friction-fit QC fitting.

11. The liquid-gas separator assembly of claim 1, wherein the liquid-gas separator assembly is characterized by a lack of electrical components and consists essentially of the QC fitting and the LG separator unit.

12. The liquid-gas separator assembly of claim 1, further comprising a flexible water hose coupled to an open nozzle end of the water nozzle to thereby transfer the extracted liquid water away from the FCS.

13. The liquid-gas separator assembly of claim 12, wherein the liquid-gas separator assembly is characterized by a lack of electrical components and consists essentially of the QC fitting, the LG separator unit, and the flexible water hose.

14. A motor vehicle, comprising:
a vehicle body;
a plurality of road wheels attached to the vehicle body;
an electric motor attached to the vehicle body and configured to drive one or more of the road wheels to thereby propel the motor vehicle;
a fuel cell system (FCS) attached to the vehicle body and operable to power the electric motor, the FCS including a fuel cell stack and an FCS exhaust pipe fluidly connected to the fuel cell stack to expel an exhaust stream from the FCS; and
a passive-type liquid-gas separator assembly including:
a quick-connect (QC) fitting having a hollow fitting body with longitudinally spaced and opposing first and second open QC ends, the first open QC end of the fitting body being physically mounted on and fluidly sealed to the FCS exhaust pipe to thereby receive the exhaust stream expelled from the FCS; and
a liquid-gas (LG) separator unit having an elongated separator body with longitudinally spaced and opposing first and second open LG ends, the first LG open end of the separator body being physically mounted on and fluidly sealed to the second open QC end to thereby releasably couple the LG separator unit to the FCS exhaust pipe and receive therefrom the exhaust stream through the QC fitting, the LG separator unit being configured to extract liquid water entrained in the exhaust stream, eject the liquid water through a hollow and cylindrical water nozzle extending axially through the center of the separator body and projecting from the second open LG end, and expel the exhaust stream through the second open LG end of the separator body.

15. A method of manufacturing a liquid-gas separator assembly for a fuel cell system (FCS), the FCS including a fuel cell stack and an FCS exhaust pipe fluidly connected to the fuel cell stack and configured to expel an exhaust stream from the FCS, the method comprising:
receiving a quick-connect (QC) fitting having a fitting body with opposing first and second open QC ends;
coupling the first open QC end of the fitting body to the FCS exhaust pipe to thereby receive the exhaust stream expelled from the FCS;
receiving a liquid-gas (LG) separator unit having a separator body with opposing first and second open LG ends; and
coupling the first LG open end of the separator body to the second open QC end to thereby releasably couple the LG separator unit to the FCS exhaust pipe and receive therefrom the exhaust stream through the QC fitting, the LG separator unit being configured to extract liquid water entrained in the exhaust stream, eject the liquid water through a water nozzle extending axially within the separator body, and expel the exhaust stream through the second open LG end.

16. The method of claim 15, wherein the separator body contains a first internal fluid chamber adjoining the first LG open end, a second internal fluid chamber adjoining the second LG open end, and a helical ramp interposed between and separating the first and second internal fluid chambers.

17. The method of claim 16, wherein the water nozzle includes a hollow cylinder coaxially aligned with the first and second LG open ends of the separator body, and the helical ramp adjoins and wraps helically around the hollow cylinder of the water nozzle.

18. The method of claim 17, wherein the LG separator unit further includes a dam wall extending radially inside the separator body and projecting from a terminal end of the helical ramp, and wherein the water nozzle includes a fluid port extending transversely through the hollow cylinder and aligned with a radially inward end of the dam wall.

19. The method of claim 15, wherein the FCS exhaust pipe has a pipe diameter, the first and second LG open ends of the separator body have respective first and second diameters, and the water nozzle has a nozzle diameter, and wherein the first and second diameters are approximately equal to or greater than the pipe diameter, and the nozzle diameter is less than the pipe diameter.

20. The method of claim 15, further comprising coupling a flexible water hose to an open nozzle end of the water nozzle to thereby transfer the extracted liquid away water from the FCS.
